(19) United States
(12) Patent Application Publication
(10) Pub. No.: US 2023/0296728 A1
(43) Pub. Date: Sep. 21, 2023

(54) RADAR DETERMINATION CIRCUITRY AND RADAR DETERMINATION METHOD

(71) Applicant: Sony Group Corporation, Tokyo (JP)

(72) Inventors: Daniel Felipe ARDILA PALOMINO, Stuttgart (DE); Gerd SPALINK, Stuttgart (DE)

(73) Assignee: Sony Group Corporation, Tokyo (JP)

(21) Appl. No.: 18/119,860

(22) Filed: Mar. 10, 2023

(30) Foreign Application Priority Data
Mar. 18, 2022 (EP) 22163058.5

(51) Int. Cl. G01S 7/40; G01S 7/35; G01S 13/42

(52) U.S. Cl. CPC G01S 7/4021; G01S 7/354; G01S 13/42

(57) ABSTRACT

The present disclosure generally pertains to radar determination circuitry configured to:
measure a first position of a radar source and a second position of the radar source with respect to a reference coordinate system of a vehicle, wherein the first position and the second position differ from each other for synchronizing the movement of the radar source with a measurement frame including multiple chirp sequences for distinguishing multiple targets; and
determine, for each of the multiple targets, a target parameter based on the synchronized movement of the radar source with the measurement frame.

### CROSS-REFERENCE TO RELATED APPLICATION

This application claims priority to European Application No. 22163058.5, filed Mar. 18, 2022, the entire contents of which are incorporated herein by reference.

### TECHNICAL FIELD

The present disclosure generally pertains to radar determination circuitry and a radar determination method.

### TECHNICAL BACKGROUND

It is expected that in the coming years autonomous vehicles are introduced to the market, such that self-driving cars will start to be found on the roads. The successful implementation of autonomous vehicles may cause engineering challenges, so that it may be possible to guarantee that the features of these vehicles work properly in diverse scenarios.

One relevant feature for navigation tasks is mapping, which may refer to creating a representation of the environment using the collected data and an estimation of the position of the ego-vehicle in the world.

Such mapping may be carried out by radar devices, for example.

Generally, mapping algorithms for radar data are known and although there exist techniques for mapping the environment using radar data, it is generally desirable to provide radar determination circuitry and a radar determination method.

### SUMMARY

According to a first aspect, the disclosure provides radar determination circuitry configured to:
measure a first position of a radar source and a second position of the radar source with respect to a reference coordinate system of a vehicle, wherein the first position and the second position differ from each other for synchronizing the movement of the radar source with a measurement frame including multiple chirp sequences for distinguishing multiple targets; and
determine, for each of the multiple targets, a target parameter based on the synchronized movement of the radar source with the measurement frame.

According to a second aspect, the disclosure provides a radar determination method comprising:
measuring a first position of a radar source and a second position of the radar source with respect to a reference coordinate system of a vehicle, wherein the first position and the second position differ from each other for synchronizing the movement of the radar source with a measurement frame including multiple chirp sequences for distinguishing multiple targets; and
determining, for each of the multiple targets, a target parameter synchronized movement of the radar source with the measurement frame.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1a depicts a scene with objects detected by a not-moving radar, wherein the radar does not move;

FIG. 1b depicts a scene with objects detected by a longitudinally moving radar;

FIG. 1c depicts a scene with objects detected by a laterally moving radar;

FIG. 1d depicts a scene with objects detected by longitudinally and laterally moving radar;

FIG. 2 depicts an embodiment according to the present disclosure in which a radar source is a moving mirror;

FIG. 3 depicts a further embodiment of radar determination circuitry according to the present disclosure;

FIG. 4 depicts, in a block diagram, an embodiment of a radar determination method according to the present disclosure;

FIG. 5 depicts, in a block diagram, a further embodiment of a radar determination method according to the present disclosure in which the radar source is moved;

FIG. 6 depicts, in a block diagram, an embodiment of a radar determination method according to the present disclosure in which a vibration is imparted to the radar source;

FIG. 7 depicts, in a block diagram, an embodiment of a radar determination method according to the present disclosure in which an acceleration of the radar source is determined;

FIG. 8 depicts a measurement result when circuitry and a method according to the present disclosure is used (on the right), compared to conventional circuitry and methods in the diagram (on the left);

FIG. 9 depicts a radar processing pipeline according to the present disclosure;

FIG. 10 depicts a timing diagram according to the present disclosure; and

FIG. 11 depicts a block diagram of a radar detection method according to the present disclosure.

### DETAILED DESCRIPTION OF EMBODIMENTS

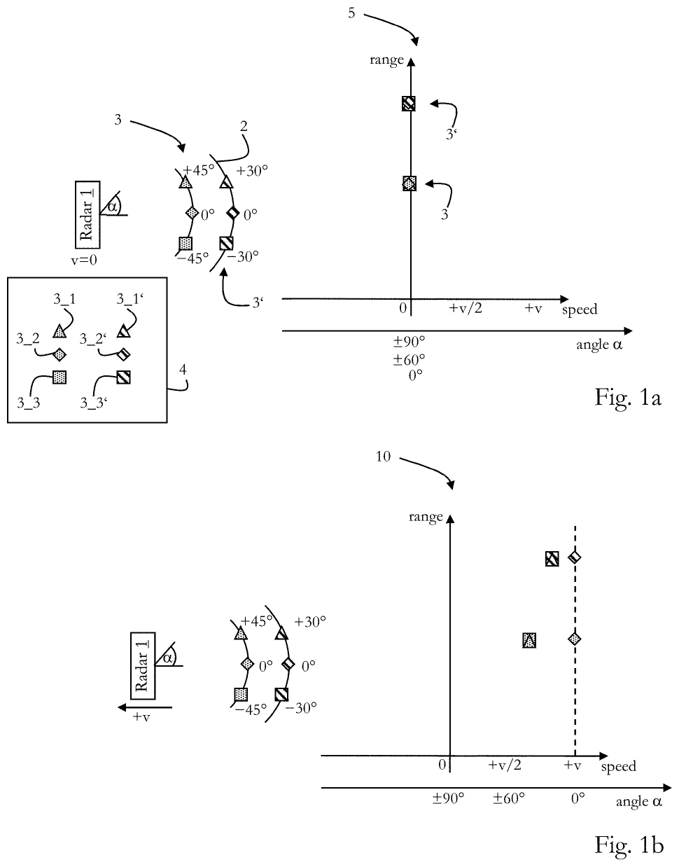

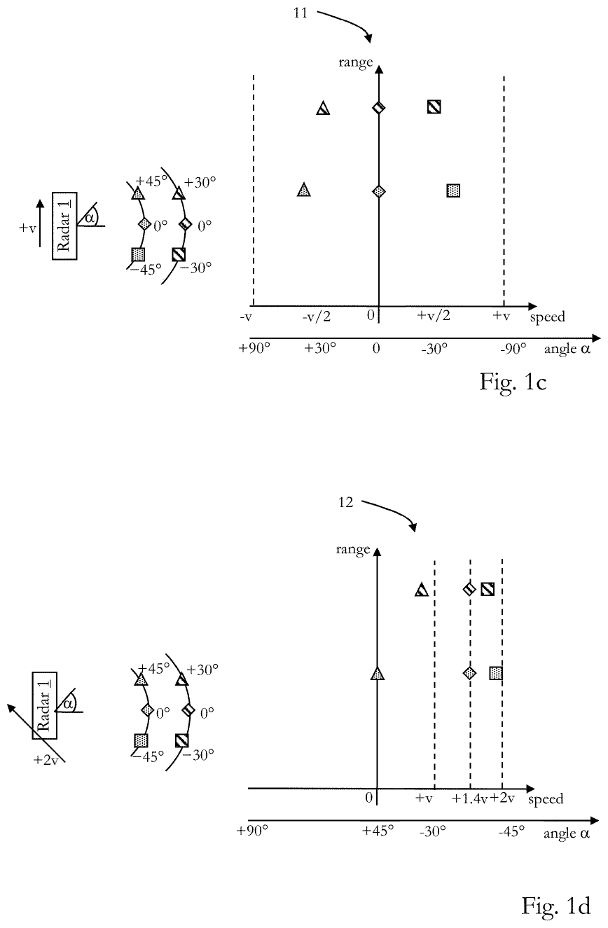

Before a detailed description of the embodiments starting with of FIG. 1a is given, general explanations are made.

As mentioned in the outset, radar mapping algorithms are generally known. However, state of the art automotive radar may detect significantly fewer targets in static scenarios (i.e., when the vehicle stops) in contrast to when the vehicle is moving.

For mapping tasks, since few detections are measured, a consequence may be that the resulting maps are sparse and cannot capture many (important) details of the environment.

It has been recognized that it may be desirable to provide a radar mounted in a vehicle that uses deliberate motion when the vehicle is static. Such motion may allow for target separation in a Doppler domain thus solving a degradation.

It has further been recognized that it is desirable to generate a detailed map of a static environment even if the vehicle is not moving.

Therefore, some embodiments pertain to radar determination circuitry configured to: measure a first position of a radar source and a second position of the radar source with respect to a reference coordinate system of a vehicle, wherein the first position and the second position differ from each other for synchronizing the movement of the radar source with a measurement frame including multiple chirp sequences for distinguishing multiple targets; and determine, for each of the multiple targets, a target parameter based on the synchronized movement of the radar source with the measurement frame.

Circuitry may pertain to any entity or multitude of entities which may be configurable for processing radar data, such as a processor (e.g., a CPU (central processing unit), GPU (graphics processing unit)) or multiple processors, also of different types, an FPGA (field-programmable gate array), or the like.

Furthermore, the circuitry may include one or multiple sensors for measuring a position of the radar source, but the present disclosure is not limited to that case since “measuring” according to the present disclosure may also refer to a determination of the position(s) based on radar data or sensor data.

The first and the second positions may lie in the same frame of reference, i.e., in a vehicle coordinate system. For example, the radar source may be provided in a vehicle (e.g., a car, ship, plane, or the like) or more specifically, in an automotive context. The vehicle may move with a constant or non-constant velocity, but the positions of the radar source may be measured with respect to the same reference point in the vehicle, such that the movement of the vehicle does not influence the position of the radar source.

However, the first position may differ from the second position which may be caused due to a displacement or a movement of the radar source with respect to the vehicle coordinate system (coordinate system of the vehicle). The displacement or movement may be caused actively (e.g., by a control) or passively. For example, a force may be present which may be caused by the movement of the vehicle (e.g., due to some type of acceleration), such that the radar source may be moved passively.

The present disclosure may be applied when a vehicle is moving or not moving. For example, if the vehicle is not moving (i.e., static), angles of objects which are positioned next to each other may not be resolved properly.

For example, in an automotive context, a scene may not be properly resolved in which different objects are positioned next to each other. It has been recognized that, e.g., a lateral moving radar may obtain more detection points than a static radar. Hence, according to the present disclosure, artificial relative velocity of the targets in the scene with respect to the radar sensor may be induced by moving the radar source.

For example, an artificial linear movement mechanism may be applied which may move the radar sensor in a linear trajectory in a cyclical way, for example. The trajectory of the movement may depend on certain characteristics of the radar sensors, such as a speed resolution, measurement time and maximum (unambiguous) speed. Notice that in order to improve a detection result, it may be necessary to provide for the velocity of the radar being as constant as possible during the measurement interval.

The radar may be moved in longitudinal, lateral and vertical direction(s). The radar movement may be synchronized with the radar measurement cycle, as also discussed further below.

If the radar moves laterally, the speed value may correspond to an azimuth angle of the target, whereas for longitudinal movement, an obtained speed value may not be indicative of a positive or negative angle. Moreover, a spread in speed domain may double in case of a lateral movement.

A required path length L of a trajectory in a measurement interval may depend on a radar carrier wavelength lambda and a number of useful resolution cells N in a Doppler domain: L=N*1/2. The effect may become more pronounced at higher carrier frequencies.

In some embodiments, the radar source corresponds to a moving mirror inserted in a radar's transmit and receive path. In such embodiments, the radar may remain in a fixed position and a movement distance of the mirror may be 0.7 times the longitudinal movement distance of the radar described above to achieve a similar same effect.

In some embodiments, the radar source may be moved based on vibrations and the positions may be measured by an IMU, as will also be discussed below.

The IMU's measurement may be used to trigger the start of a radar frame. For the synchronization, properties of vibrations may be used.

Generally spoken, based on the first and the second positions of the radar source, the movement of the radar source may be synchronized with a measurement frame.

For example, a measurement may be triggered when the radar source is at a predetermined position, such that based on each trigger, a measurement may be carried out.

The measurement frame may include multiple chirp sequences and in one measurement, multiple targets may be distinguished which are positioned next to each other.

In some embodiments, the radar source is only moved when the vehicle is static and not moved when the vehicle moves.

Based on the first position and on the second position, a target parameter may be determined. In other words, for each target (of multiple targets, which may be positioned next to each other, as discussed above), e.g., object, a target parameter (or object parameter) may be determined, such as an angle for each target, which could not be determined according to known methods since known methods would output the same target parameter for each target.

Depending on the movement direction and movement velocity of the radar source signal (i.e., depending on the change of the second position with respect to the first position), unresolved target parameters can be resolved differently.

For instance, a target parameter (e.g., position, angle, velocity, distance) of two targets of objects which are next to each other may not be resolved according to known methods.

However, if the radar source moves away from the two objects, on the straight line, with a predetermined velocity, the objects may be resolved. On the other hand, two objects which may lie on a line parallel to above line (i.e., displaced with respect to the radar source) may be resolved when the radar source moves perpendicular to the line.

Hence, the target parameter may be determined based on the first position and on the second position, as discussed above.

In some embodiments, the radar source may include a radar antenna, as it is commonly known, or a mirror which may reflect a radar signal (from an antenna), thereby constituting a measurement origin of the radar measurement.

Generally, there are different ways how a relative positional difference of the radar source (with respect to target(s)) or a relative speed of the radar source (with respect to the target) may be achieved, e.g., by moving the radar source (i.e., the antenna and/or the mirror) or by imparting a vibration to the radar source (i.e., the antenna and/or the mirror), or both. Moreover, the present disclosure is not limited to the case that the radar source moves since motion may be based on a relative speed of the targets, of the ego-vehicle, or the like.

Hence, in some embodiments the radar determination circuitry is further configured to: move the radar source.

In some embodiments, the radar determination circuitry is further configured to: determine the target parameter based on a trajectory between the first position and the second position.

In some embodiments, the radar determination circuitry is further configured to: trigger a radar measurement based on a movement trajectory of the radar source. For example, if a displacement of the radar source is determined to have a predetermined value (e.g., a maximum value), a measurement may be triggered.

In some embodiments, the radar determination circuitry is further configured to: impart a vibration to the radar source.

The vibration may be caused by a vibrating device or may be caused by a vibration of the vehicle (e.g., by an engine of the vehicle). However, the vibration may cause a stochastic movement, such that a movement caused by the vibration is not known in advance (hence, as stated above, the first and second positions may be measured).

Therefore, in some embodiments, the radar determination circuitry is further configured to: determine an acceleration caused by the imparted vibration.

The acceleration may be determined by an inertia measurement unit (IMU), for example, such that the first and second positions may be measured based on the acceleration, as it is generally known.

In some embodiments, the second position being different from the first position is caused due to a displacement of the radar source in the coordinate system of the vehicle, is discussed herein.

In some embodiments, the displacement is inclined with respect to a radar detection direction.

As discussed above, horizontal movement of the radar source and vertical movement of the radar source may resolve different target parameters for different targets, such that an inclined movement may resolve more target parameters at a time. The radar detection direction may refer to a direction in which radar rays are emitted.

In some embodiments, the inclination is forty-five degrees.

In some embodiments, the displacement and the radar detection direction lie in a plane parallel to a movement direction of the vehicle.

For example, in an automotive context, it may be desirable to detect objects in front of the vehicle, which may constitute a risk while driving, such that the displacement and the radar detection direction may lie in the plane in which the vehicle moves.

In some embodiments, the target parameter includes at least one of a position, a distance, a velocity, and an angle, as discussed herein.

Some embodiments pertain to a radar determination method including: measuring a first position of a radar source and a second position of the radar source with respect to a reference coordinate system of a vehicle, wherein the first position and the second position differ from each other for synchronizing the movement of the radar source with a measurement frame including multiple chirp sequences for distinguishing multiple targets; and determining, for each of the multiple targets, an target parameter based on the synchronized movement of the radar source with the measurement frame.

The radar determination method(s) according to the present disclosure may be carried out with radar determination circuitry according to the present disclosure.

In some embodiments, the radar source includes a radar antenna or a mirror, as discussed herein. In some embodiments, the radar determination method further includes: moving the radar source, as discussed herein. In some embodiments, the method further includes: determining the target parameter based on a trajectory between the first position and the second position, as discussed herein. In some embodiments, the method further includes: triggering a radar measurement based on a movement trajectory of the radar source, as discussed herein. In some embodiments, the radar determination method further includes: imparting a vibration to the radar source, as discussed herein. In some embodiments, the radar determination method further includes: determining an acceleration caused by the imparted vibration, as discussed herein. In some embodiments, the second position being different from the first position is caused due to a displacement of the radar source in the coordinate system of the vehicle, as discussed herein. In some embodiments, the displacement is inclined with respect to a radar detection direction, as discussed herein. In some embodiments, the inclination is forty-five degrees, as discussed herein. In some embodiments, the displacement and the radar detection direction lie in a plane parallel to a movement direction of the vehicle, as discussed herein. In some embodiments, the target parameter includes at least one of a position, a distance, a velocity, and an angle, as discussed herein.

In some embodiments, radar measurement intervals are synchronized with the radar source movement. For example, if the radar movement is based on a sine function, the measurement interval may be when the positional displacement (with respect to time) is roughly linear, i.e., before and after peaks and dips of the sine. This may correspond to performing a measurement when the radar velocity is around a peak or a dip.

In other words, a position of the radar source may follow a linear trajectory in the measurement interval and the radar source speed may be constant in the measurement interval. However, according to simulations which have been carried out, small deviations from the linear trajectory and from the constant speed may have satisfying results, as well.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1a, there is depicted a radar 1 emitting, in an emission angle α radar rays 2 onto objects 3 and 3′ which lie in the same plane. Objects 3 include the objects 3_1, 3_2, and 3_3, and objects 3′ includes the objects 3_1′, 3_2′, and 3_3′, as can be taken from cutline 4, wherein corresponding object angles are provided next to the objects for illustrational purposes.

The radar 1 does not move, i.e., has a velocity of zero.

As can be taken from diagram 5 on the right of FIG. 1a depicting a range versus speed and angle, respectively, objects 3 and 3′ may be determined to have different ranges, but their speed and angles may not be distinguished.

In other words, if neither the radar nor the targets move, they may only be separable in a range direction. In this embodiment, the radar detects only two targets even though there are six targets in front of the radar.

FIG. 1b depicts the same scene when the radar 1 moves away from the objects with a velocity +v.

From diagram 10, depicting range versus speed/angle, it can be taken that the range distinguishment of the objects 3 and 3′ is the same as above, but their speed/angle is resolved differently.

The objects 3_2 and 3_2′ are determined to have a velocity of +v and an angle of zero degrees, the objects 3_1 and 3_3 are determined to have a velocity of +0.707*v and an angle of 45 degrees, and the objects 3_1′ and 3_3′ have a velocity of +0.866*v and an angle of thirty degrees (v_{target}=v_{radar}* cos α, wherein v_{target} is the velocity of the target and v_{radar} is the velocity of the radar).

In other words, if the radar moves longitudinally, targets at 0° are detected at a speed corresponding to the radar speed. Targets at other angles are detected at smaller speed v=cos (α). However, whether the angle is positive or negative may not be distinguished in the embodiment of FIG. 1b.

In this embodiment, the radar detects four of the six targets.

FIG. 1c depicts the same scene when the radar 1 moves laterally (e.g., left or right with respect to the targets), i.e., perpendicular to the movement direction of FIG. 1b, with a velocity of +v.

Again, the range distinguishment is the same as above, but their speed/angle distinguishment is different, as can be taken from diagram 11.

Objects 3_2 and 3_2′ are determined to have a velocity and an angle of zero. Object 3_1′ is determined to have a velocity of −v/2 and an angle of thirty degrees. Object 3_3′ is determined to have a velocity of +v/2 and an angle of minus thirty degrees. Object 3_1 is determined to have a velocity of −0.707*v and an angle of forty-five degrees. Object 3_3 is determined to have a velocity of 0.707*v and an angle of minus forty-five degrees (v_{target}=v_{radar}* sin(45°−α), wherein v_{target} is the velocity of the target and v_{radar} is the velocity of the radar).

FIG. 1d depicts the same scene when the radar 1, with a velocity of +2 v, backwards with respect to the objects, with an inclination of forty-five degrees.

As can be taken from diagram 12, the range distinguishment is the same as before, but the velocity distinguishment is different.

Object 3_1 is determined to have a velocity of zero and an angle of forty-five degrees. Object 3_2 is determined to have a velocity of (roughly) 1.4 v and an angle of zero degrees. Object 3_3 is determined to have a velocity of 2 v and an angle of minus forty-five degrees. Object 3_1′ is determined to have a velocity of (roughly) 0.52 v and an angle of thirty degrees. Object 3_2′ is determined to have a velocity of (roughly) 1.4 v and an angle of zero degrees. Object 3_3′ is determined to have a velocity of (roughly) 1.93 v and an angle of minus thirty degrees (v_{target}=−1*v_{radar}* sin α, wherein v_{target} is the velocity of the target and v_{radar} is the velocity of the radar).

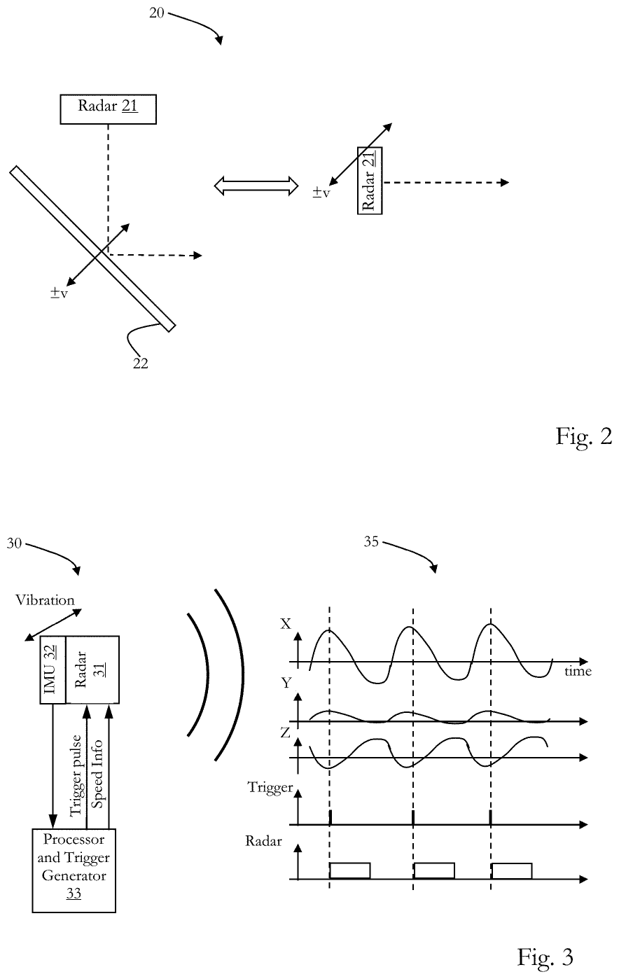

FIG. 2 depicts a further embodiment 20 of the present disclosure, in which a radar 21 emits rays onto a mirror 22. The mirror 22 is moved with a velocity ±v in a direction which is inclined forty-five degrees with respect to the radar direction. Hence, in this embodiment, the mirror 22 is the radar source. The movement of the mirror 22 is equivalent to the radar 21 being moved in said direction, as shown on the right of FIG. 2.

FIG. 3 depicts a further embodiment of radar determination circuitry 30 according to the present disclosure.

The radar determination circuitry 30 includes a radar 31 which is coupled to an IMU 32 to which a vibration is imparted. A processor and trigger generator unit 33 transmits, to the radar 31 and to the IMU 32, multiple trigger pulses and speed info. The IMU measures an acceleration based on the vibration and transmits corresponding data to the processor and trigger generator unit 33, such that the included processor can determine a first and a second position of the radar 31 for determining a target parameter, as discussed herein.

Diagrams 35, one the right of FIG. 3, depict three-dimensional positions of the radar with the coordinates X, Y, and Z versus time, as well as the trigger pulses and the corresponding radar cycles, for one measurement/determination cycle according to the present disclosure.

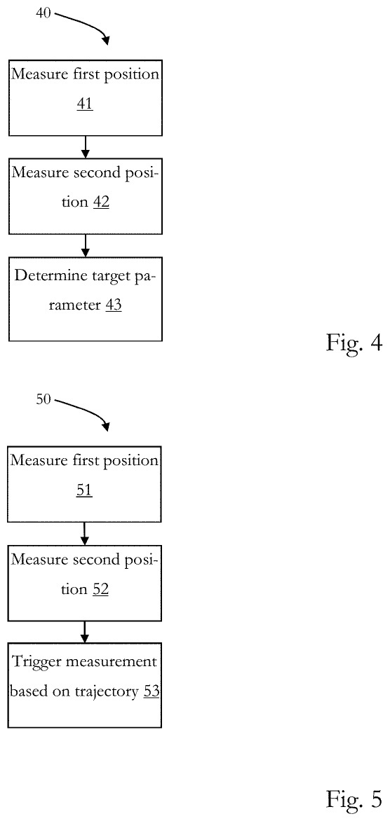

FIG. 4 depicts, in a block diagram, an embodiment of a radar determination method 40 according to the present disclosure.

At 41, a first position of a radar source (a mirror, in this embodiment) is measured based on an IMU, as discussed herein.

At 42, a second position is measured based on the IMU, as discussed herein.

At 43, a position (as target parameter) is determined (i.e., resolved) based on the first and second position, as discussed herein.

FIG. 5 depicts, in a block diagram, a further embodiment of a radar determination method 50 according to the present disclosure in which the radar source is moved.

At 51, a first position of a radar source (a mirror, in this embodiment) is measured based on a position sensor provided in a vehicle.

At 52, the radar source is moved with a motor.

At 53, a second position of the radar source is measured based on the position sensor.

At 54, a distance (as target parameter) is determined (i.e., resolved), as discussed herein.

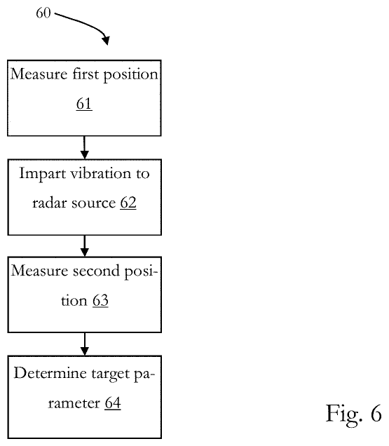

FIG. 6 depicts, in a block diagram, an embodiment of a radar determination method 60 according to the present disclosure in which a vibration is imparted to the radar source.

At 61, a first position of a radar source (a radar antenna, in this embodiment) is measured based on a position sensor provided in a vehicle.

At 62, a vibration is imparted to the radar source with a vibration device, as discussed herein.

At 63, a second position of the radar source is measured based on an IMU, as discussed herein.

At 64, a velocity (as target parameter) is determined (i.e., resolved) based on the first and second position, as discussed herein.

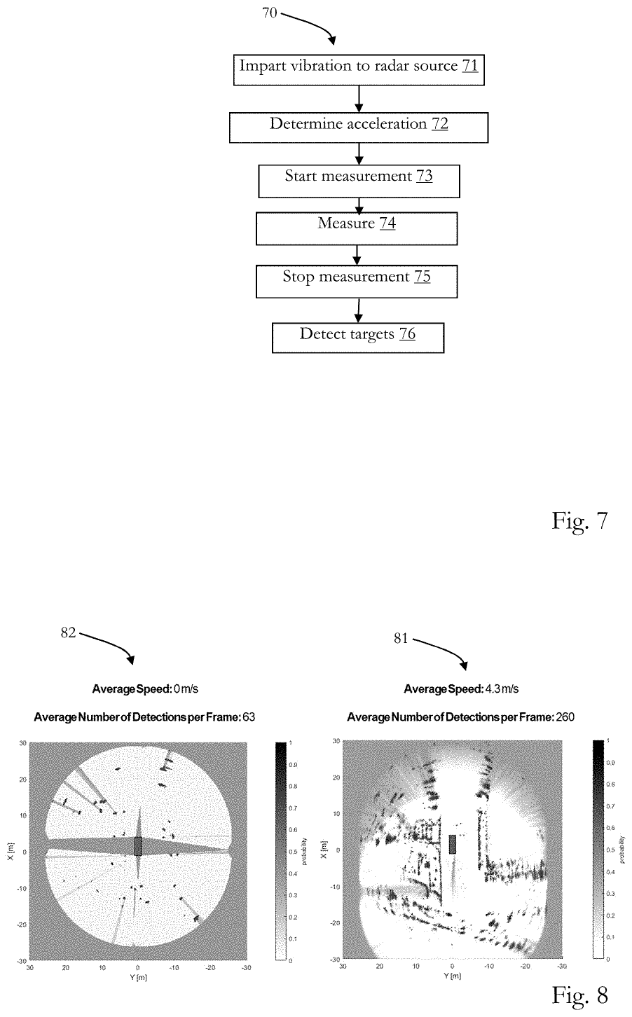

FIG. 7 depicts, in a block diagram, an embodiment of a radar determination method 70 according to the present disclosure in which an acceleration of the radar source is determined.

At 71, vibration is imparted to the radar source based on a vibration of an engine of a vehicle.

At 72, an acceleration of the radar source caused by the vibration is determined with an IMU, as discussed herein.

At 73, a measurement is started, which is carried out during 74.

At 75, the measurement is stopped.

At 76, targets are detected based on their resolved target parameters, as discussed herein.

FIG. 8 depicts a measurement result 81 when circuitry and a method according to the present disclosure is used (on the right) in a standard processing pipeline (discussed under reference of

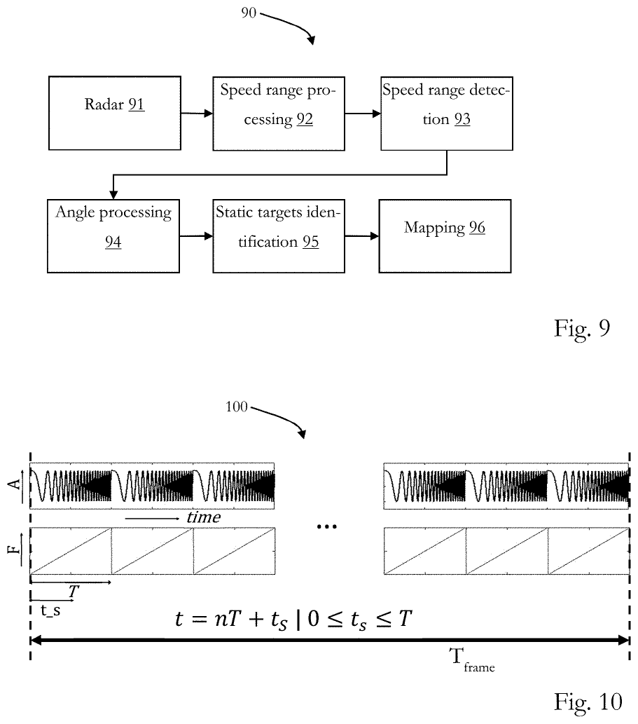

FIG. 9), compared to conventional circuitry and methods in the diagram on the left.

On the left, diagram 82, the average speed of the radar is zero, thereby resulting in a low number of detections per frame, i.e., sixty-three.

On the diagram depicting results of the present disclosure, the average number of detections is two-hundred and sixty, wherein an average speed of the radar is 4.3 m/s.

Generally, the diagrams 81 and 82 show occupancy grid maps. The result 82 on the left was obtained while the ego-platform was static, while for the result 81 on the right, the ego-platform was moving at roughly 4.3 m/s. The two results represent the same place, but the quality and details of the result 81 on the right is improved compared to the result 82.

Diagram 82 is also obtained by using a standard processing pipeline, which is explained in the following under reference of FIG. 9 in order to understand how the present disclosure provides an improvement with respect to the prior art.

FIG. 9 depicts a radar processing pipeline 90, as it is generally known The pipeline 90 starts with a radar unit 91 which refers to radar hardware and also includes all the acquisition infrastructure to capture the radar data. The result of this block is a four-dimensional cube that carries the information of the received radar reflections.

The second block in the pipeline refers a speed range processing unit carrying out a 2D Fast Fourier Transform applied to the radar data to calculate the speed and range information. In this stage, a representation of the measured radar signal is created so that a distribution in the speed-range domain of the level of the targets can be established.

In the next step, a detection algorithm 93 is applied in the speed-range domain. This means that an algorithm (typically a Constant False Alarm Rate algorithm) is used to identify all the peaks in the speed-range diagram. Notice that, since the detection process is applied in the speed-range domain, targets that have similar (how similar depends on the radar resolution) speed and range properties will be represented by a single peak.

When the ego-platform is moving, the radial speed of the targets that is measured by the radar depends on the relative angle of the target. This means that even if the targets are static and at the same distance, if they are at different relative angles to the radar, they will appear at different speed-range cells (as also discussed under reference of FIGS. 1b to 1d). This increases the number of targets detected by the “Speed-Range Detection” block. In contrast, when the ego-vehicle is not moving all static targets will have a 0 m/s relative radial velocity and all targets will concentrate in the 0 m/s speed cells (also discussed under reference of FIG. 1a).

Once the detection algorithm 93 is applied, the list of detected targets is passed to the “Angle Processing” block 94, where the angle of arrival information of each one is calculated. In general, it is possible to separate multiple targets that were in the same speed-range cell, but this may be challenging and only a single angle may be estimated in this block.

At 95, the “Static Targets Identification” discriminate the static targets and those are used by the “Mapping” block 96 to create a representation of the environment.

FIG. 10 depicts a timing diagram 100 according to the present disclosure. The timing diagram 100 includes an amplitude (A) versus time diagram demonstrating a chirp according to the present disclosure, and a frequency (F) versus time diagram including a chirp time T.

Multiple chirps are carried out which constitute a frame, which has the time T_{frame}. A current time is expressed with the formula t=nT+t_s, wherein t_s is a time value measured from the start time of the current chirp to the current point in time.

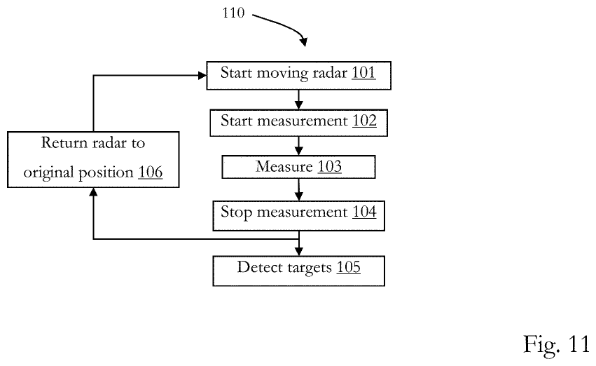

FIG. 11 depicts a block diagram of a radar detection method according to the present disclosure.

At 101, a radar source is moved, as discussed herein.

At 102, a radar measurement is started, as discussed herein.

At 103, the measurement is carried out.

At 104, the measurement is stopped.

At 105, target parameters are resolved and thus, targets are detected.

At 106, the radar is returned to its original position.

It should be recognized that the embodiments describe methods with an exemplary ordering of method steps. The specific ordering of method steps is however given for illustrative purposes only and should not be construed as binding. For example, the ordering of 61 and 62 in the embodiment of FIG. 6 may be exchanged. Also, the ordering of 71 and 72 in the embodiment of FIG. 7. Other changes of the ordering of method steps may be apparent to the skilled person.

Please note that the division of the circuitry 33 into units processor and trigger generator is only made for illustration purposes and that the present disclosure is not limited to any specific division of functions in specific units. For instance, the circuitry 33 could be implemented by a respective programmed processor, field programmable gate array (FPGA) and the like.

The methods discussed herein can also be implemented as a computer program causing a computer and/or a processor, such as processor 33 discussed above, to perform the method, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) Radar determination circuitry configured to:
   measure a first position of a radar source and a second position of the radar source with respect to a reference coordinate system of a vehicle, wherein the first position and the second position differ from each other for synchronizing the movement of the radar source with a measurement frame including multiple chirp sequences for distinguishing multiple targets; and
   determine, for each of the multiple targets, a target parameter based on the synchronized movement of the radar source with the measurement frame.
(2) The radar determination circuitry of (1), wherein the radar source includes a radar antenna or a mirror.
(3) The radar determination circuitry of (1) or (2), further configured to:
   trigger a radar measurement based on a movement trajectory of the radar source.
(4) The radar determination circuitry of anyone of (1) to (3), further configured to:
   impart a vibration to the radar source.
(5) The radar determination circuitry of (4), further configured to:
   determine an acceleration caused by the imparted vibration.
(6) The radar determination circuitry of anyone of (1) to (5), wherein the second position being different from the first position is caused due to a displacement of the radar source in the coordinate system of the vehicle.
(7) The radar determination circuitry of (6), wherein the displacement is inclined with respect to a radar detection direction.
(8) The radar determination circuitry of (7), wherein the inclination is forty-five degrees.
(9) The radar determination circuitry of (7) or (8), wherein the displacement and the radar detection direction lie in a plane parallel to a movement direction of the vehicle.
(10) The radar determination circuitry of anyone of (1) to (9), wherein the target parameter includes at least one of a position, a distance, a velocity, and an angle.
(11) A radar determination method comprising:
   measuring a first position of a radar source and a second position of the radar source with respect to a reference coordinate system of a vehicle, wherein the first position and the second position differ from each other for synchronizing the movement of the radar source with a measurement frame including multiple chirp sequences for distinguishing multiple targets; and
   determining, for each of the multiple targets, a target parameter based on the synchronized movement of the radar source with the measurement frame.
(12) The radar determination method of (11), wherein the radar source includes a radar antenna or a mirror.
(13) The radar determination method of (11) or (12), further comprising:
   triggering a radar measurement based on a movement trajectory of the radar source..
(14) The radar determination method of anyone of (11) to (13), further comprising:
   imparting a vibration to the radar source.
(15) The radar determination method of (14), further comprising:
   determining an acceleration caused by the imparted vibration.
(16) The radar determination method of anyone of (11) to (15), wherein the second position being different from the first position is caused due to a displacement of the radar source in the coordinate system of the vehicle.
(17) The radar determination method of (16), wherein the displacement is inclined with respect to a radar detection direction.
(18) The radar determination method of (17), wherein the inclination is forty-five degrees.
(19) The radar determination method of (17) or (18), wherein the displacement and the radar detection direction lie in a plane parallel to a movement direction of the vehicle.
(20) The radar determination method of anyone of (11) to (19), wherein the target parameter includes at least one of a position, a distance, a velocity, and an angle.
(21) A computer program comprising program code causing a computer to perform the method according to anyone of (11) to (20), when being carried out on a computer.
(22) A non-transitory computer-readable recording medium that stores therein a computer program product, which, when executed by a processor, causes the method according to anyone of (11) to (20) to be performed.

1. Radar determination circuitry configured to:
measure a first position of a radar source and a second position of the radar source with respect to a reference coordinate system of a vehicle, wherein the first position and the second position differ from each other for synchronizing the movement of the radar source with a measurement frame including multiple chirp sequences for distinguishing multiple targes; and
determine, for each of the multiple targets, a target parameter based on synchronized movement of the radar source with the measurement frame.

2. The radar determination circuitry of claim 1, wherein the radar source includes a radar antenna or a mirror.

3. The radar determination circuitry of claim 1, further configured to:
trigger a radar measurement based on a movement trajectory of the radar source.

4. The radar determination circuitry of claim 1, further configured to:
impart a vibration to the radar source.

5. The radar determination circuitry of claim 4, further configured to:
determine an acceleration caused by the imparted vibration.

6. The radar determination circuitry of claim 1, wherein the second position being different from the first position is caused due to a displacement of the radar source in the coordinate system of the vehicle.

7. The radar determination circuitry of claim 6, wherein the displacement is inclined with respect to a radar detection direction.

8. The radar determination circuitry of claim 7, wherein the inclination is forty-five degrees.

9. The radar determination circuitry of claim 7, wherein the displacement and the radar detection direction lie in a plane parallel to a movement direction of the vehicle.

10. The radar determination circuitry of claim 1, wherein the target parameter includes at least one of a position, a distance, a velocity, and an angle.

11. A radar determination method comprising:
measuring a first position of a radar source and a second position of the radar source with respect to a reference coordinate system of a vehicle, wherein the first position and the second position differ from each other for synchronizing the movement of the radar source with a measurement frame including multiple chirp sequences for distinguishing multiple targets; and
determining, for each of the multiple targets, a target parameter based on the synchronized movement of the radar source with the measurement frame.

12. The radar determination method of claim 11, wherein the radar source includes a radar antenna or a mirror.

13. The radar determination method of claim 11, further comprising:
triggering a radar measurement based on a movement trajectory of the radar source.

14. The radar determination method of claim 11, further comprising:
imparting a vibration to the radar source.

15. The radar determination method of claim 14, further comprising:
determining an acceleration caused by the imparted vibration.

16. The radar determination method of claim 11, wherein the second position being different from the first position is caused due to a displacement of the radar source in the coordinate system of the vehicle.

17. The radar determination method of claim 16, wherein the displacement is inclined with respect to a radar detection direction.

18. The radar determination method of claim 17, wherein the inclination is forty-five degrees.

19. The radar determination method of claim 17, wherein the displacement and the radar detection direction lie in a plane parallel to a movement direction of the vehicle.

20. The radar determination method of claim 11, wherein the target parameter includes at least one of a position, a distance, a velocity, and an angle.
